(19) United States
(12) Patent Application Publication
(10) Pub. No.: US 2023/0169475 A1
(43) Pub. Date: Jun. 1, 2023

(54) SYSTEM AND METHOD FOR OMNIDIRECTIONAL SYNCING OF PAYMENT DATA

(71) Applicant: Chargezoom, Inc., Irvine, CA (US)

(72) Inventor: Matthew Dubois, Irvine, CA (US)

(73) Assignee: Chargezoom, Inc., Irvine, CA (US)

(21) Appl. No.: 17/587,351

(22) Filed: Jan. 28, 2022

Related U.S. Application Data
(60) Provisional application No. 63/285,063, filed on Dec. 1, 2021.

(51) Int. Cl. G06Q 20/06; G06Q 20/40; G06Q 20/38

(52) U.S. Cl. CPC G06Q 20/06; G06Q 20/401; G06Q 20/389; G06Q 20/3821

(57) ABSTRACT

A computer system for reconciling cashless financial transactions across distinct data platforms can include: at least one processor; and memory including a set of instructions for reconciling cashless financial transactions across distinct data platforms, wherein the set of instructions, with the at least one processor, is configured to cause the computer system to: receive payment data for a cashless transaction from a payment processing data platform; receive invoice data for the cashless transaction from an accounting data processing platform; reconcile the payment data for the cashless transaction with the invoice data for the cashless transaction; and render a display of the reconciled cashless transaction data to a user associated with the transaction.

### CROSS-REFERENCE TO RELATED APPLICATIONS

The present application claims priority to U.S. Provisional Patent Application Ser. No. 63/285,063, filed on Dec. 1, 2021, and entitled “System and Method for Omnidirectional Syncing of Payment Data,” the contents of which are incorporated herein for all purposes by this reference.

### FIELD

The present invention relates to the field of cashless payment technologies and, more particularly, to a system and method for omnidirectional syncing of payment data between cashless payment technologies.

### BACKGROUND

An increasing number of businesses and consumers are utilizing cashless payment methods including credit cards and near field communication (NFC) devices to provide payment for goods and services. A cashless transaction can include a point of sale input (e.g., a card swiper, website data entry, etc.), a payment gateway in communication with the point of sale input that functions to transmit payment details to the payment processor, and a merchant-side set of software tools such as an enterprise resource planning (ERP) software platform or an accounting software suite.

Typical payment gateways include a technological feature in which a merchant (user) can access or retrieve a set of transactions in a first data format (e.g., CSV) and then manually upload, input, and/or reconcile the set of transactions into a second data format within the ERP or accounting software platform. Similarly, existing technologies are unable to map, transform, match, normalize, standardize, and/or reconcile invoice and sales data, thus requiring additional manual data entry and reconciliation. To date, existing technologies are also unable to automatically receive, access, input, and/or generate complete transaction data sets, thus requiring additional manual data entry (if any) and/or excessive recoding, customization, or additions to existing technologies (e.g., ERM, CRM, accounting platforms).

Accordingly, an improved system and method for automatically and omnidirectionally synchronizing data within a cashless payment network can be beneficial.

### SUMMARY

Certain embodiments of the present invention can provide solutions to the technical problems and needs in the art that have not yet been fully identified, appreciated, or solved by current cashless payment network technologies. For example, some embodiments of the present invention pertain to a method, system, and/or computer program product for automatically synchronizing data sets between merchant-side software applications and payment gateways.

In one embodiment, a computer-implemented method for reconciling cashless financial transactions across distinct data platforms includes: by a computer system, receiving payment data for a cashless transaction from a payment processing data platform; by the computer system, receiving invoice data for the cashless transaction from an accounting data processing platform; by the computer system, reconciling the payment data for the cashless transaction with the invoice data for the cashless transaction; and by the computer system, rendering a display of the reconciled cashless transaction data to a user associated with the transaction.

In some embodiments, the method can also include, by the computer system, transmitting the reconciled cashless transaction data to the accounting data processing platform.

In some embodiments, the method can also include, in response to a type of accounting data processing platform, by the computer system, mapping a set of data fields from the payment data into a set of data fields from the invoice data such that the reconciled cashless transaction data is readable by the accounting data processing platform.

In some embodiments, the method can also include: receiving, from the accounting data platform at the computer system, an application programming interface (API) call requesting the reconciled cashless transaction data; by the computer system, authenticating the accounting data platform with the user associated with the cashless transaction; and in response to an authenticated API call, transmitting the reconciled cashless transaction data from the computer system to the accounting data platform.

In some embodiments, the method can also include, prior to rendering the display of the reconciled cashless transaction data to a user associated with the cashless transaction: by the computer system, mapping a set of data fields from the payment data into a set of data fields from the invoice data; by the computer system, hosting a database accessible by the user associated with the cashless transaction; by the computer system, storing the reconciled transaction data in a database accessible by the user associated with the cashless transaction; and by the computer system, permitting remote access to the reconciled cashless transaction data in the database in response to authentication of a device associated with the user associated with the cashless transaction.

In some embodiments, the method can also include, wherein receiving payment data for the cashless transaction from a payment processing data platform includes: by the computer system, submitting an API call to the payment processing data platform, the API call including a unique identifier including one or more of: the user associated with the cashless transaction; a cashless payment identifier; a cashless transaction identifier; a purchaser identifier; or a vendor identifier.

In some embodiments, the method can also include, wherein receiving invoice data for the cashless transaction from an accounting data processing platform includes: by the computer system, submitting an API call to the accounting data processing data platform, the API call including a unique identifier including one or more of: the user associated with the transaction; a cashless payment identifier; a cashless transaction identifier; a purchaser identifier; or an invoice identifier.

In another embodiment, a computer system for reconciling cashless financial transactions across distinct data platforms can include: at least one processor; and memory including a set of instructions for reconciling cashless financial transactions across distinct data platforms, wherein the set of instructions, with the at least one processor, is configured to cause the computer system to: receive payment data for a cashless transaction from a payment processing data platform; receive invoice data for the cashless transaction from an accounting data processing platform; reconcile the payment data for the cashless transaction with the invoice data for the cashless transaction; and render a display of the reconciled cashless transaction data to a user associated with the transaction.

In some embodiments, the computer system is further configured to transmit the reconciled cashless transaction data to the accounting data processing platform.

In some embodiments, the computer system is further configured to, in response to a type of accounting data processing platform, map a set of data fields from the payment data into a set of data fields from the invoice data such that the reconciled cashless transaction data is readable by the accounting data processing platform.

In some embodiments, the computer system is further configured to: receive, from the accounting data platform, an application programming interface (API) call requesting the reconciled cashless transaction data; authenticate the accounting data platform with the user associated with the cashless transaction; and in response to an authenticated API call, transmit the reconciled cashless transaction data to the accounting data platform.

In some embodiments, the computer system is further configured to, prior to rendering the display of the reconciled cashless transaction data to a user associated with the cashless transaction: map a set of data fields from the payment data into a set of data fields from the invoice data; host a database accessible by the user associated with the cashless transaction; store the reconciled transaction data in a database accessible by the user associated with the cashless transaction; and permit remote access to the reconciled cashless transaction data in the database in response to authentication of a device associated with the user associated with the cashless transaction.

In some embodiments, the computer system is further configured to submit an API call to the payment processing data platform, the API call including a unique identifier including one or more of: the user associated with the cashless transaction; a cashless payment identifier; a cashless transaction identifier; a purchaser identifier; or a vendor identifier.

In some embodiments, the computer system is further configured to submit an API call to the accounting data processing data platform, the API call including a unique identifier including one or more of: the user associated with the transaction; a cashless payment identifier; a cashless transaction identifier; a purchaser identifier; or an invoice identifier.

In another embodiment, a computer program embodied on a non-transitory computer readable medium, when executed, is configured to cause at least one processor to: receive payment data for a cashless transaction from a payment processing data platform; receive invoice data for the cashless transaction from an accounting data processing platform; reconcile the payment data for the cashless transaction with the invoice data for the cashless transaction; and render a display of the reconciled cashless transaction data to a user associated with the transaction.

In some embodiments, the computer program product is further configured to cause at least one processor to transmit the reconciled cashless transaction data to the accounting data processing platform.

In some embodiments, the computer program product is further configured to cause at least one processor to: in response to a type of accounting data processing platform, map a set of data fields from the payment data into a set of data fields from the invoice data such that the reconciled cashless transaction data is readable by the accounting data processing platform; receive, from the accounting data platform, an application programming interface (API) call requesting the reconciled cashless transaction data; authenticate the accounting data platform with the user associated with the cashless transaction; and in response to an authenticated API call, transmit the reconciled cashless transaction data to the accounting data platform.

In some embodiments, the computer program product is further configured to cause at least one processor to, prior to rendering the display of the reconciled cashless transaction data to a user associated with the cashless transaction: map a set of data fields from the payment data into a set of data fields from the invoice data; host a database accessible by the user associated with the cashless transaction; store the reconciled transaction data in a database accessible by the user associated with the cashless transaction; and permit remote access to the reconciled cashless transaction data in the database in response to authentication of a device associated with the user associated with the cashless transaction.

In some embodiments, the computer program product is further configured to submit an API call to the payment processing data platform, the API call including a unique identifier including one or more of: the user associated with the cashless transaction; a cashless payment identifier; a cashless transaction identifier; a purchaser identifier; or a vendor identifier.

In some embodiments, the computer program product is further configured to submit an API call to the accounting data processing data platform, the API call including a unique identifier including one or more of: the user associated with the transaction; a cashless payment identifier; a cashless transaction identifier; a purchaser identifier; or an invoice identifier.

These and other embodiments, and variations and alternatives thereof, are described below in detail with reference to the following figures.

### BRIEF DESCRIPTION OF THE FIGURES

In order that the advantages of certain embodiments of the invention will be readily understood, a more particular description of the invention briefly described above will be rendered by reference to specific embodiments that are illustrated in the appended figures. While it should be understood that these figures depict only typical embodiments of the invention and are not therefore to be considered to be limiting of its claimed scope, the invention will be described and explained with additional specificity and detail through the use of the accompanying claimed, in which:

FIG. 1 is a schematic diagram of a computer system operating environment according to an embodiment of the present invention;

FIG. 2 is an architectural diagram of a computer system configured to automatically and omnidirectionally synchronize disparate data sets within a cashless payment network, according to an embodiment of the present invention;

FIG. 3 is a schematic representation of an example operational environment of a computer system, according to an embodiment of the present invention;

FIG. 4 is a flow chart representation of a method executable by the computer system, according to an embodiment of the present invention;

FIG. 5 is a schematic view of a user interface, according to an embodiment of the present invention;

FIG. 6 is a schematic view of a user interface, according to an embodiment of the present invention; and

FIG. 7 is a schematic view of a user interface, according to an embodiment of the present invention.

### DETAILED DESCRIPTION OF THE EMBODIMENTS

### 1. Overview

Generally, various embodiments of the computer system 100 are configured to automatically reconcile and synchronize distinct data sets in an end-to-end manner between a credit card network and a merchant accounting system, thereby eliminating technological inefficiencies and errors on the par to the payment gateway and the merchant (user). In operation, various embodiments of the computer system 100 can be configured to automatically pull invoice date from the merchant accounting software and also pull the transaction identification data from the payment gateway into the merchant accounting software and synchronize, apply, and/or reconcile the transaction identification data with the invoice. In some embodiments, the computer system 100 can then push, transmit, or transfer the reconciled transaction data to one or both of the accounting platform or the payment gateway platform. In other embodiments, the computer system 100 can selectively permit user access into an account (e.g., a cloud-based platform) that permits a user to access, manipulate, transfer, or transmit the reconciled transaction data. In still other embodiments, the computer system 100 can be configured to host and interface with a set of user accounts (e.g., users 1 through N), each of which is associated with its own accounting platform and one or more payment gateways. Therefore the computer system 100 can function as a cloud-based, end-to-end, accounting, invoicing, and reconciliation platform that allows an arbitrary number of users to match and reconcile payment and invoice data for any number of cashless payments seamlessly and automatically.

### 2. Benefits

As described in detail below, the computer system 100 can be configured to retrieve, standardize, normalize, and reconcile financial data sets between a merchant's accounting system (e.g., CRM, accounting and/or ERP software), a payment gateway or payment processing system, and one or more cashless payment entities such as a credit card company, bank, or other electronic payment platform. In doing so, the system can synchronize/push invoice and merchant data to the payment platform, synchronize/pull transaction data from the payment gateway into the merchant accounting system, generate and/or create actual payment records within the merchant accounting system, and reconcile and/or synchronize the transaction cycle from invoicing, payment, returns, and/or refunds on behalf of the merchant and the payment platform.

One benefit of the various embodiments of the computer system 100 is that the computer system 100 provides seamless, end-to-end fidelity of the entirety of the transaction (including invoicing, payment, returns, and/or refunds) without the need for additional technologies or human intervention. In doing so, the computer system 100 can increase the efficiency with which both merchants and payment processors reconcile, settle, and close out transaction cycles, thus permitting real time or near real time transfer of funds between the various entities associated with the transaction. Moreover, the computer system 100 can eliminate any need for excessive or additional software tools, scripts, or programs to assist in the import, export, translation, and reconciliation of the financial and transactional data associated with a purchase, sale, return, and/or refund. The computer system 100 can also greatly increase the efficiencies of the underlying software platforms by providing seamless and real-time or near real-time data exchange on all sides of a transaction, thereby increasing the pace at which the ancillary software platforms (e.g., CRM software, ERP software, accounting software, payment processing software) can process and close each phase of a transaction.

### 3. Computer System Architecture

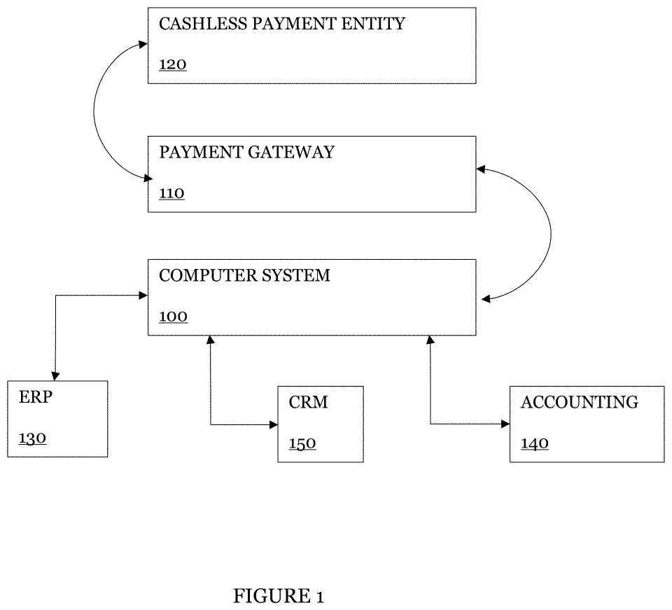

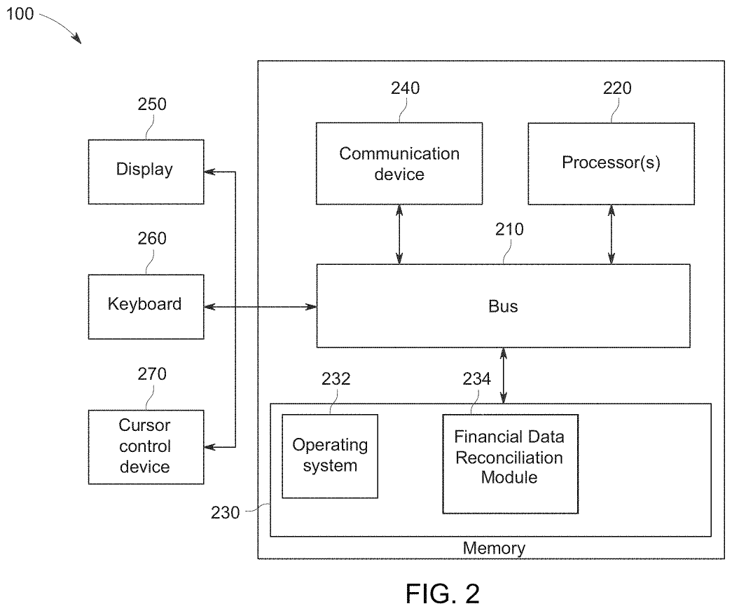

Generally, the methods and techniques described herein are performed by a computer system 100, as shown in FIG. 1. For example, FIG. 2 is an exemplary architectural diagram illustrating a computer system 100 configured to automatically reconcile and synchronize distinct data sets in an end-to-end manner between a credit card network and a merchant accounting system according to an embodiment of the present invention. In some embodiments, the computer system 100 is configured as a cloud based platform or service that can access other software applications, services, servers, datasets, and/or databases associated with the user-merchant, payor, credit card network, etcetera.

In some embodiments, the computer system 100 can be one or more of the computing systems depicted and/or described herein. The computer system 100 can include a bus 210 or other communication mechanism for communicating information, and one or more processor(s) 220 coupled to the bus 210 for processing information. The processor(s) 220 can be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. The processor(s) 220 can also have multiple processing cores, and at least some of the cores can be configured to perform specific functions. Multi-parallel processing can be used in some embodiments. In certain embodiments, at least one of the processor(s) 220 can be a neuromorphic circuit that includes processing elements that mimic biological neurons. In some embodiments, neuromorphic circuits might not require the typical components of a Von Neumann computing architecture.

The computer system 100 can also include a memory 230 for storing information and instructions to be executed by the processor(s) 220. The memory 230 can be comprised of any combination of Random Access Memory (RAM), Read Only Memory (ROM), flash memory, cache, static storage such as a magnetic or optical disk, or any other types of non-transitory computer-readable media or combinations thereof. Non-transitory computer-readable media can be any available media that can be accessed by the processor(s) 220 and can include volatile media, non-volatile media, or both. The media can also be removable, non-removable, or both.

Additionally, the computer system 100 can include a communication device 240, such as a transceiver, to provide access to a communications network via a wireless and/or wired connection. In some embodiments, the communication device 240 can be configured to use Frequency Division Multiple Access (FDMA), Single Carrier FDMA (SC-FDMA), Time Division Multiple Access (TDMA), Code Division Multiple Access (CDMA), Orthogonal Frequency Division Multiplexing (OFDM), Orthogonal Frequency Division Multiple Access (OFDMA), Global System for Mobile (GSM) communications, General Packet Radio Service (GPRS), Universal Mobile Telecommunications System (UMTS), cdma2000, Wideband CDMA (W-CDMA), High-Speed Downlink Packet Access (HSDPA), High-Speed Uplink Packet Access (HSUPA), High-Speed Packet Access (HSPA), Long Term Evolution (LTE), LTE Advanced (LTE-A), 802.11x, Wi-Fi, Zigbee, Ultra-WideBand (UWB), 802.16x, 802.15, Home Node-B (HnB), Bluetooth, Radio Frequency Identification (RFID), Infrared Data Association (IrDA), Near-Field Communications (NFC), fifth generation (5G), New Radio (NR), any combination thereof, and/or any other currently existing or future-implemented communications standard and/or protocol without deviating from the scope of the claimed invention. In some embodiments, the communication device 240 can include one or more antennas that are singular, arrayed, phased, switched, beamforming, beamsteering, a combination thereof, and or any other antenna configuration without deviating from the scope of the claimed invention.

The processor(s) 220 are further coupled via the bus 210 to a display 250, such as a plasma display, a Liquid Crystal Display (LCD), a Light Emitting Diode (LED) display, a Field Emission Display (FED), an Organic Light Emitting Diode (OLED) display, a flexible OLED display, a flexible substrate display, a projection display, a 4K display, a high definition display, a Retina® display, an In-Plane Switching (IPS) display, or any other suitable display for displaying information to a user. The display 250 can be configured as a touch (haptic) display, a three dimensional (3D) touch display, a multi-input touch display, a multi-touch display, etc. using resistive, capacitive, surface-acoustic wave (SAW) capacitive, infrared, optical imaging, dispersive signal technology, acoustic pulse recognition, frustrated total internal reflection, etcetera. Any suitable display device and haptic I/O can be used without deviating from the scope of the claimed invention.

A keyboard 260 and a cursor control device 270, such as a computer mouse, a touchpad, etc., are further coupled to the bus 210 to enable a user to interface with the computer system 100. However, in certain embodiments, a physical keyboard and mouse might not be present, and the user can interact with the computer system 100 solely through display 250 and/or a touchpad (not shown). Any type and combination of input devices can be used as a matter of design choice. In certain embodiments, no physical input device and/or display is present. For instance, the computer system 100 can be configured as a cloud-based or remote server-based system, in which case the user can interact with computer system 100 remotely via another system (not shown) in communication therewith. In still other embodiments, the computer system 100 can operate autonomously, semi-autonomously, or by implementing machine learning techniques.

The memory 230 stores software modules that provide functionality when executed by the processor(s) 220. The modules can include an operating system 232 for computer system 100. The modules can further include a financial data reconciliation module 234 that is configured to perform all or part of the processes, techniques, or methods described herein or derivatives thereof. The computer system 100 can include one or more additional modules that include additional functionality.

One skilled in the art will appreciate that a “computer system” could be embodied as a server, an embedded computing system, a personal computer, a console, a personal digital assistant (PDA), a cell phone, a tablet computing device, a quantum computing system, or any other suitable computing device, or combination of devices without deviating from the scope of the claimed invention. Presenting the above-described functions as being performed by a “computer system” is not intended to limit the scope of the claimed invention in any way, but is intended to provide one example of the many embodiments of the claimed invention. Indeed, methods, systems, and apparatuses disclosed herein can be implemented in localized and distributed forms consistent with computing technology, including cloud computing systems.

It should be noted that some of the computer system 100 features described in this specification have been presented as modules, in order to emphasize their implementation independence more particularly. For example, a module can be implemented as a hardware circuit comprising custom very large scale integration (VLSI) circuits or gate arrays, off-the-shelf semiconductors such as logic chips, transistors, or other discrete components. A module can also be implemented in programmable hardware devices such as field programmable gate arrays, programmable array logic, programmable logic devices, graphics processing units, or the like.

A module can also be at least partially implemented in software for execution by various types of processors. An identified unit of executable code can, for instance, include one or more physical or logical blocks of computer instructions that can, for instance, be organized as an object, procedure, or function. Nevertheless, the executables of an identified module need not be physically located together, but can include disparate instructions stored in different locations that, when joined logically together, comprise the module and achieve the stated purpose for the module. Further, modules can be stored on a computer-readable medium, which can be, for instance, a hard disk drive, flash device, RAM, tape, and/or any other such non-transitory computer-readable medium used to store data without deviating from the scope of the invention.

Indeed, a module of executable code could be a single instruction, or many instructions, and can even be distributed over several different code segments, among different programs, and across several memory devices. Similarly, operational data can be identified and illustrated herein within modules, and can be embodied in any suitable form and organized within any suitable type of data structure. The operational data can be collected as a single data set, or can be distributed over different locations including over different storage devices, and can exist, at least partially, merely as electronic signals on a system or network.

The process steps performed in by the system 100 can be performed by a computer program, encoding instructions for the processor(s) to perform at least part of the process(es), techniques, or methods described herein, in accordance with embodiments of the claimed invention. The computer program can be embodied on a non-transitory computer-readable medium. The computer-readable medium can be, but is not limited to, a hard disk drive, a flash device, RAM, a tape, and/or any other such medium or combination of media used to store data. The computer program can include encoded instructions for controlling the processor(s) of a computer system (e.g., the processor(s) 220 of the computer system 100 of FIG. 2) to implement all or part of the process steps described in herein, which can also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, an ASIC, or any other suitable device.

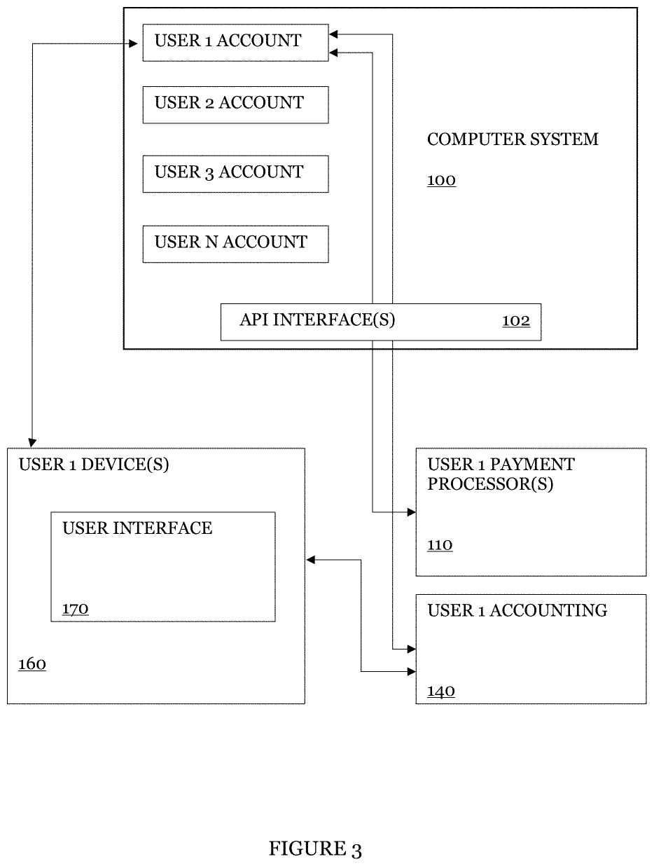

As shown in FIGS. 1 and 3, in one embodiment the computer system 100 can be connected, for example through one or more application programming interfaces (APIs) 102, to a payment processor 110, which is in turn in communication through industry standard and encrypted channels with one or more cashless payment entities 120 (e.g., credit card networks, banks, electronic payment systems, etcetera). The computer system 100 can also be connected to one or more merchant-side financial software platforms, including an enterprise resource planning (ERP) platform 130, an accounting platform 140, and/or a customer relations management (CRM) platform 150. In some embodiments, one or more of the ERP platform 130, the accounting platform 140, and the CRM platform 150 can be cloud-based software-as-a-service (SaaS) computing platforms. Additionally or alternatively, in some embodiments, one or more of the computer system 100, the payment processor 110, and the cashless payment entity 120 can be implemented in a remote server and/or cloud-based software platform.

In other embodiments, the computer system 100 can be connected and/or connectable to one or more of the ERP platform 130, the accounting platform 140, the CRM platform 150 the payment processor no, and/or the cashless payment entity 120 via one or more application programming interfaces (APIs) that permit the computer system 100 to: submit a request for data from the associated platform; receive or pull data from the associated platform; respond to a request for data from the associated platform; and transmit or push data to the associated platform. In some embodiments, the computer system 100 and associated platforms can execute REST APIs. In other embodiments, the computer system 100 can associated platforms can execute SOAP APIs. In still other embodiments, the computer system 100 and associated platforms can execute APIs of other types or formats.

As shown in FIGS. 1 and 3, embodiments of the computer system 100 can: retrieve and/or access transaction data from the payment gateway no; and push the transaction data into the ERP software 130, accounting software 140, and/or CRM software 150 through one or more API interfaces 102. In operation, the computer system 100 can further function to transform, translate, and/or map transaction data into a universally or omni-directional readable format such that, for an example cashless transaction, the payment data receivable from the payment processor no is imported into and/or reconciled with the invoice data from the accounting platform 140. Therefore, the computer system 100 can: retrieve, map, and reconcile invoice and payment data from a transaction into a single data form that includes all of the necessary data for the merchant and/or the payment processor 110 to close, amend, or alter a particular cashless transaction.

As shown in FIG. 3, the computer system 100 can host and intermediate a set of user accounts, each of which is connected to and/or associated with a user device 160, a user payment processor(s) 110, and/or a user accounting platform 140. For example, an example user (USER 1) can, through her associated user device 160, remotely access her account on the computer system 100, connect her accounting platform 140 to the computer system 100, and connect her payment processor(s) 140 to the computer system 100. In response, the computer system 100 execute the methods and techniques described herein to: receive payment data for a cashless transaction from the payment processing data platform 110; receive invoice data for the cashless transaction from an accounting data processing platform 140; reconcile the payment data for the cashless transaction with the invoice data for the cashless transaction; and render a display of the reconciled cashless transaction data to a user associated with the transaction. In one variation of the embodiments, the computer system 100 can render a display for the user viewable on a user interface 170 on her user device 160. In another variation of the embodiments, the computer system 100 can push or transmit the reconciled cashless transaction data to the accounting data processing platform 110 and/or the payment processing platform 110 such that the user's accounting records are automatically reconciled and updated and/or the payment processing entity has a confirmed and reconciled dataset of the cashless transaction that it is processing on behalf of the user.

In another variation of the embodiments, the computer system 100 can further manipulate, transform, normalize, and/or map disparate data types or data formats into a single data format for the user. For example, certain accounting principles or regulations may require accounting records to be presented in a particular format or with certain prescribed fields, for example dual entry and generally accepted accounting principles (GAAP) accounting standards. Accordingly, the computer system 100 can also determine a type of accounting platform 140 in use by the user or receive an accounting platform configuration from either the user or the accounting platform 140. In response to the type of accounting data processing platform, the computer system 100 can then map a set of data fields from the payment data into a set of data fields from the invoice data such that the reconciled cashless transaction data is readable by the accounting data processing platform 140.

Additionally or alternatively, the computer system 100 can, in response to the type of payment processing platform, map a set of data fields from the invoice data into a set of data fields from the payment data such that the reconciled cashless transaction data is readable by the payment processing data platform no.

In another variation of the embodiments, the computer system 100 can directly transmit or import the reconciled cashless transaction data into the accounting data platform 140, which is either directly accessible to the user on the user device 160 and/or remotely accessible to the user via a connection to a cloud-based or server-based accounting data platform 140. In this variation of the embodiments, the computer system 100 can receive an API call from the accounting data platform 140 requesting the reconciled cashless transaction data. Either in concert with or in addition to the API call, the computer system 100 can then authenticate the accounting data platform 140 (e.g., a user account on the accounting data platform 140) with the user associated with the cashless transaction. In response to an authenticated API call, the computer system 100 can then transmit the reconciled cashless transaction data from the computer system 100 to the accounting data platform 140.

In another variation of the embodiments, the computer system 100 can directly transmit or import the reconciled cashless transaction data into the payment processing platform no, which is either directly accessible to the user on the user device 160 and/or remotely accessible to the user via a connection to a cloud-based or server-based payment processing platform 110. In this variation of the embodiments, the computer system 100 can receive an API call from the payment processing platform no requesting the reconciled cashless transaction data. Either in concert with or in addition to the API call, the computer system 100 can then authenticate the payment processing platform 110 (e.g., a user account on the payment processing platform 110) with the user associated with the cashless transaction. In response to an authenticated API call, the computer system 100 can then transmit the reconciled cashless transaction data from the computer system 100 to the payment processing platform 110.

In another variation of the embodiments, the computer system 100 can be configured to host a user account (e.g., a cloud-based hosted service) through which the user can access her reconciled cashless transaction data via her user device 160. Accordingly, prior to rendering the display of the reconciled cashless transaction data to the user, the computer system 100 can map a set of data fields from the payment data into a set of data fields from the invoice data and host a database accessible by the user associated with the cashless transaction on which database the transaction data (raw and reconciled) is stored and accessible. The computer system 100 can further permit remote access to the reconciled cashless transaction data in the database in response to authentication of a user device 160 associated with the user. The computer system 100 can authenticate the user device 160 through the initial API setup, described above. Alternatively, the computer system 100 can separately authenticate the user device 160 upon user account login, for example through password entry, authentication challenge question(s), two-factor authentication techniques, biometric authentication, and/or any combination or subcombination of the foregoing.

In other variations of the embodiments, the computer system 100 can request and/or transmit via APIs including identifying data associated with the user, the user account, the transaction, the purchaser, and/or the vendor. For example, in receiving payment data for the cashless transaction from the payment processing data platform 110, the computer system can submit an API call to the payment processing data platform no that includes a unique identifier or combination of identifiers. For example, each cashless transaction can include at least the following data: the user (either an individual or an entity), a cashless payment identifier (e.g., a credit card number), a cashless transaction identifier (e.g., an alphanumeric transaction record), a purchaser identifier, and/or a vendor identifier (e.g., for instances in which the vendor and the merchant are non-identical). Therefore, an API call can include one or more identifiers that enables the computer system 100 to readily import, store, access, and manipulate the payment data. For example, an API call can identify: a user (merchant), the credit card number used in the transaction (or a portion thereof), and a purchaser identifier (or a portion thereof such as name, billing zip code, etcetera).

Additionally or alternatively, in receiving invoice data for the cashless transaction from an accounting data processing platform 140, the computer system can submit an API call to the accounting data processing data platform 140 that includes a unique identifier or combination of identifiers. For example, each cashless transaction can include at least the following data: the user (either an individual or an entity), a cashless payment identifier (e.g., a credit card number), a cashless transaction identifier (e.g., an alphanumeric transaction record), a purchaser identifier, and/or an invoice identifier. Therefore, an API call can include one or more identifiers that enables the computer system 100 to readily import, store, access, and manipulate the accounting data. For example, an API call can identify: a user (merchant), the credit card number used in the transaction (or a portion thereof), and an invoice number from the accounting data processing platform 140.

In another variation of the embodiments, the computer system 100 can use any or all of the foregoing identifying data to match accounting data (e.g., invoice data) with the payment data prior to reformatting, importing, exporting, and/or reconciling the data sets.

In another variation of the embodiments, the computer system 100 can adapt, alter, and/or amend invoices and transactions in response to a user input. For example, if the user elects to surcharge an invoice payment, the computer system 100 can: process the updated total (invoice amount plus surcharge amount), synchronize the updated transaction total with the updated invoice with a new line item for the surcharge. Additionally, the computer system 100 can process and update the payment end of the transaction simultaneously or substantially simultaneously with updating the invoice.

### 4. Method

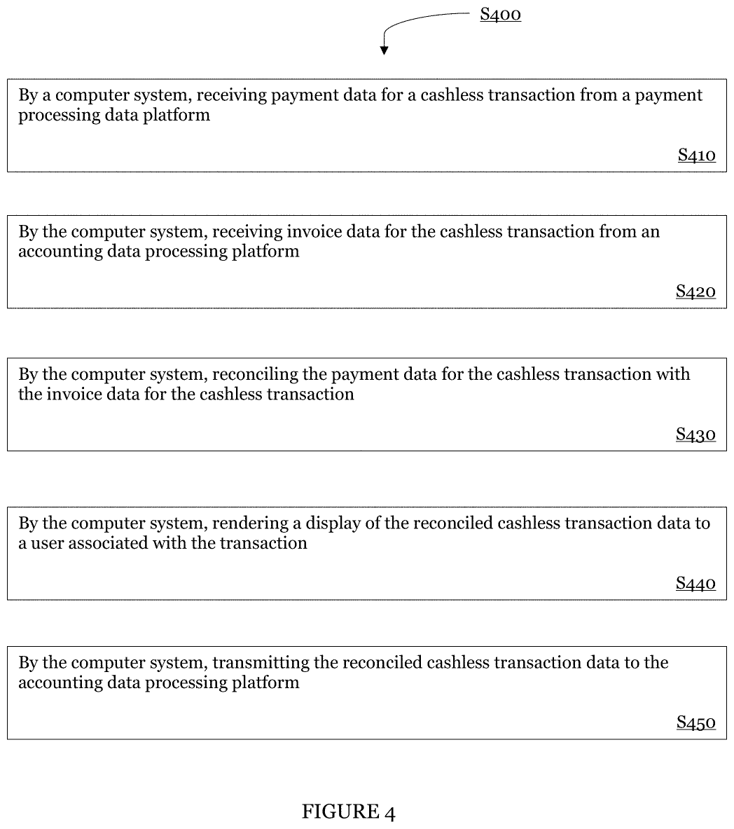

In some variations of the embodiments, the computer system 100 can be configured to implement or execute one or more techniques or methods. As shown in FIG. 4, one method S400 for reconciling cashless financial transactions across distinct data platforms can include: receiving payment data for a cashless transaction from a payment processing data platform in Block S410; and receiving invoice data for the cashless transaction from an accounting data processing platform in Block S420. In this variation of the embodiments, the method S400 can also include: reconciling the payment data for the cashless transaction with the invoice data for the cashless transaction in Block S430; and rendering a display of the reconciled cashless transaction data to a user associated with the transaction in Block S440.

In another variation of the embodiments, the method S400 can also include transmitting the reconciled cashless transaction data to the accounting data processing platform in Block S450.

In another variation of the embodiments, the method S400 can further include: by the computer system, mapping a set of data fields from the payment data into a set of data fields from the invoice data such that the reconciled cashless transaction data is readable by the accounting data processing platform. As noted above, each type of accounting data processing platform and/or payment data processing platform can include one or more fields, data types, or data formats that are desirable and/or necessary for best accounting practices, accounting compliance, and/or information system fidelity. Additionally or alternatively, the method S400 can also include, in response to the type of payment processing platform, mapping a set of data fields from the invoice data into a set of data fields from the payment data such that the reconciled cashless transaction data is readable by the payment processing data platform 110.

In some variations of the embodiments, the computer system 100 can execute one or more blocks of the method S400 via one or more APIs. For example, in some variations of the embodiments, the method S400 can include receiving, from the accounting data platform at the computer system, an application programming interface (API) call requesting the reconciled cashless transaction data. For example, as described above, the accounting data platform associated with the user can, either intermittently, regularly, or upon user request, transmit a request for data via one or more APIs. The method S400 can also include, by the computer system, authenticating the accounting data platform with the user associated with the cashless transaction; and in response to an authenticated API call, transmitting the reconciled cashless transaction data from the computer system to the accounting data platform for rendering, display, manipulation, and/or storage in the accounting data platform.

In still other variations of the embodiments, the method S400 can function on a computer system 100 configured as a cloud-based or server-based software platform through which a user can access her invoice and payment data. In another variation of the embodiment, the computer system 100 can execute one or more blocks of the method S400 prior to rendering the display of the reconciled cashless transaction data to the user. For example, the method S400 can include: by the computer system, mapping a set of data fields from the payment data into a set of data fields from the invoice data; and by the computer system, hosting a database accessible by the user associated with the cashless transaction. In these variations of the embodiments, the method S400 can also include by the computer system, storing the reconciled transaction data in a database accessible by the user associated with the cashless transaction; and by the computer system, permitting remote access to the reconciled cashless transaction data in the database in response to authentication of a device associated with the user associated with the cashless transaction. As noted above, the method S400 can further include blocks, executable by the computer system 100, to ensure proper authentication of the user device to the database, including for example authentication of the user device through the initial API setup, upon user account login (e.g., password entry), based upon authentication challenge question(s), two-factor authentication techniques, biometric authentication, and/or any combination or subcombination of the foregoing.

In still other variations of the embodiments, the computer system 100 can execute the method S400 to match and/or pair the invoice (accounting data) and the payment (payment processing data) in order to manipulate, transform, map, and/or reconcile the paired sets of data into a single, complete data set. As noted above, the computer system 100 can execute additional or alternative blocks of the method S400 to request, via API call, unique transaction identifiers from both the payment processing data platform and the accounting data platform. The unique transaction identifiers can include, for example, any combination or subcombination of the following: the user associated with the cashless transaction; a cashless payment identifier, a cashless transaction identifier, a purchaser identifier, a vendor identifier, and/or an invoice identifier.

### 5. Example Implementations

As described above, the computer system 100 can execute blocks of the method S400 in a distributed network of devices, servers, and/or cloud-based platforms. In some variations of the embodiments, the computer system 100 can be a stand-alone, cloud-based, and remotely accessible computing platform that interacts with ancillary devices, servers, and/or cloud-based platforms. In other variations of the embodiments, the computer system 100 can be integrated into or integral with one of the ancillary devices, servers, and/or cloud based platforms.

For example, in another variation of the embodiments, the computer system 100 can be integrated into or integral with the payment processing platform 110 such that the payment processing platform 110 can provide end-to-end transaction data reconciliation for its merchants/users, along with other benefits of the type described herein.

In another variation of the embodiments, the computer system 100 can be integrated into or integral with the accounting data processing platform 140 such that the accounting data processing platform 140 can provide end-to-end transaction data reconciliation for its merchants/users, along with other benefits of the type described herein.

In still another variation of the embodiments, the computer system 100 can be configured as a stand-alone service (e.g., a cloud-based platform) that interacts with ancillary devices, servers, and/or cloud-based platforms via APIs as described above.

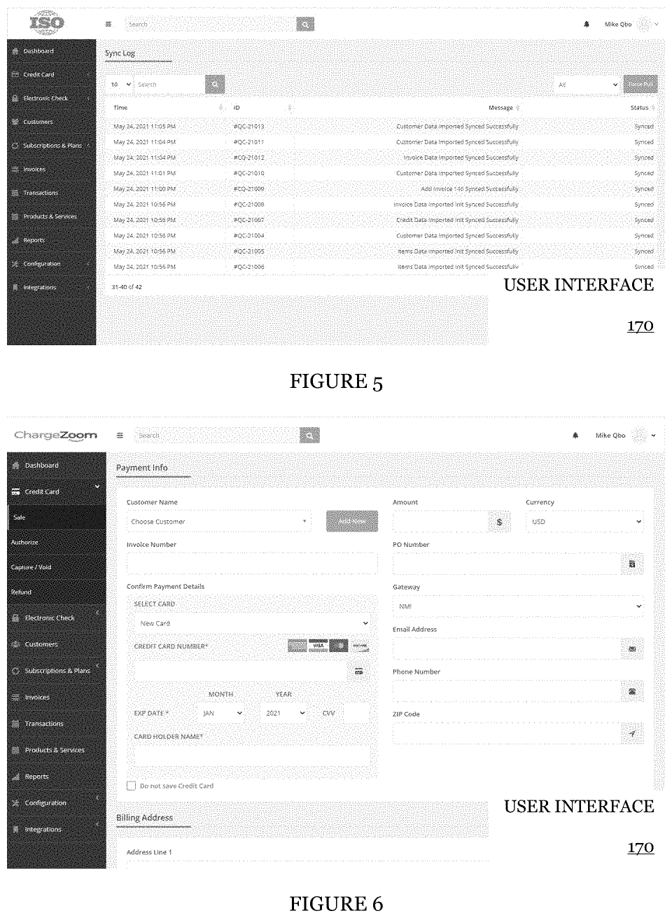

For example, FIGS. 5, 6, and 7 are schematic renditions of a user interface 170 (e.g., rendered and displayed on a user device 160) with a computer system 100 configured as a stand-alone, cloud-based platform. As shown, FIG. 5 depicts a synchronization log displayable to a merchant/user that the computer system 100 renders and displays on the user device 160 to show a user a state/status of the various inter-platform synchronizations implemented by the computer system 100.

FIG. 6 depicts a payment information input field displayable to a merchant/user through which a merchant/user can input various invoicing data into a set of fields, including for example: customer name, invoice number, amount, PO number, gateway (payment processor identifier), credit card information, purchaser name, billing zip code, etcetera. As noted above, in some variations of the embodiments, the computer system 100 can access some or all of this data in order to properly pair the invoice with the payment processing data.

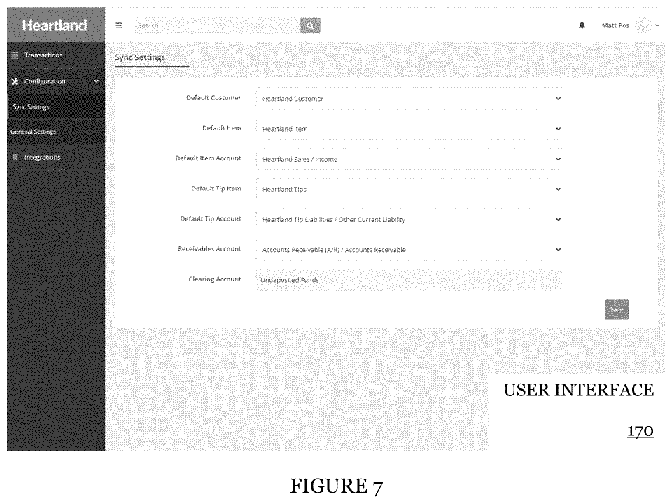

FIG. 7 illustrates a sync settings selection interface displayable to a merchant/user and through which a merchant/user can select one or more parameters of the synchronization and reconciliation techniques and methods described herein. For example, in some variations of the embodiments, the computer system 100 can select customers, items, accounting classifications, and accounts (e.g., accounts on a ledger) that the computer system 100 will synchronize and reconcile in execution of the method S400 described above.

It will be readily understood that the components of various embodiments of the present invention, as generally described and illustrated in the figures herein, can be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification can be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics can be combined in any suitable manner in one or more embodiments.

It should be noted that reference throughout this specification to features, advantages, or similar language does not imply that all of the features and advantages that can be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification can, but do not necessarily, refer to the same embodiment.

Furthermore, the described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention.

One having ordinary skill in the art will readily understand that the invention as discussed above can be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

What is claimed is:

1. A computer-implemented method for reconciling cashless financial transactions across distinct data platforms, the method comprising:
by a computer system, receiving payment data for a cashless transaction from a payment processing data platform;
by the computer system, receiving invoice data for the cashless transaction from an accounting data processing platform;
by the computer system, reconciling the payment data for the cashless transaction with the invoice data for the cashless transaction; and
by the computer system, rendering a display of the reconciled cashless transaction data to a user associated with the transaction.

2. The computer-implemented method of claim 1, further comprising:
by the computer system, transmitting the reconciled cashless transaction data to the accounting data processing platform.

3. The computer-implemented method of claim 2, further comprising:
in response to a type of accounting data processing platform, by the computer system, mapping a set of data fields from the payment data into a set of data fields from the invoice data such that the reconciled cashless transaction data is readable by the accounting data processing platform.

4. The computer-implemented method of claim 3, further comprising:
receiving, from the accounting data platform at the computer system, an application programming interface (API) call requesting the reconciled cashless transaction data;
by the computer system, authenticating the accounting data platform with the user associated with the cashless transaction; and
in response to an authenticated API call, transmitting the reconciled cashless transaction data from the computer system to the accounting data platform.

5. The computer-implemented method of claim 1, further comprising, prior to rendering the display of the reconciled cashless transaction data to a user associated with the cashless transaction:
by the computer system, mapping a set of data fields from the payment data into a set of data fields from the invoice data;
by the computer system, hosting a database accessible by the user associated with the cashless transaction;
by the computer system, storing the reconciled transaction data in a database accessible by the user associated with the cashless transaction; and
by the computer system, permitting remote access to the reconciled cashless transaction data in the database in response to authentication of a device associated with the user associated with the cashless transaction.

6. The computer-implemented method of claim 1, wherein receiving payment data for the cashless transaction from a payment processing data platform comprises:
by the computer system, submitting an API call to the payment processing data platform, the API call comprising a unique identifier comprising one or more of:
the user associated with the cashless transaction;
a cashless payment identifier;
a cashless transaction identifier;
a purchaser identifier; or
a vendor identifier.

7. The computer-implemented method of claim 7, wherein receiving invoice data for the cashless transaction from an accounting data processing platform comprises:
by the computer system, submitting an API call to the accounting data processing data platform, the API call comprising a unique identifier comprising one or more of:
the user associated with the transaction;
a cashless payment identifier;
a cashless transaction identifier;
a purchaser identifier; or
an invoice identifier.

8. A computer system for reconciling cashless financial transactions across distinct data platforms, the system comprising:
at least one processor; and
memory comprising a set of instructions for reconciling cashless financial transactions across distinct data platforms, wherein the set of instructions, with the at least one processor, is configured to cause the computer system to:
receive payment data for a cashless transaction from a payment processing data platform;
receive invoice data for the cashless transaction from an accounting data processing platform;
reconcile the payment data for the cashless transaction with the invoice data for the cashless transaction; and
render a display of the reconciled cashless transaction data to a user associated with the transaction.

9. The computer system of claim 8, wherein the set of instructions, with the at least one processor, is further configured to:
transmit the reconciled cashless transaction data to the accounting data processing platform.

10. The computer system of claim 9, wherein the set of instructions, with the at least one processor, is further configured to:
in response to a type of accounting data processing platform, map a set of data fields from the payment data into a set of data fields from the invoice data such that the reconciled cashless transaction data is readable by the accounting data processing platform.

11. The computer system of claim 10, wherein the set of instructions, with the at least one processor, is further configured to:
receive, from the accounting data platform, an application programming interface (API) call requesting the reconciled cashless transaction data;
authenticate the accounting data platform with the user associated with the cashless transaction; and
in response to an authenticated API call, transmit the reconciled cashless transaction data to the accounting data platform.

12. The computer system of claim 8, wherein the set of instructions, with the at least one processor, is further configured to:
prior to rendering the display of the reconciled cashless transaction data to a user associated with the cashless transaction:
map a set of data fields from the payment data into a set of data fields from the invoice data;
host a database accessible by the user associated with the cashless transaction;
store the reconciled transaction data in a database accessible by the user associated with the cashless transaction; and
permit remote access to the reconciled cashless transaction data in the database in response to authentication of a device associated with the user associated with the cashless transaction.

13. The computer system of claim 8, wherein the set of instructions, with the at least one processor, being configured to receive payment data for the cashless transaction from a payment processing data platform comprises:
causing the computer system to submit an API call to the payment processing data platform, the API call comprising a unique identifier comprising one or more of:
the user associated with the cashless transaction;
a cashless payment identifier;
a cashless transaction identifier;
a purchaser identifier; or
a vendor identifier.

14. The computer system of claim 13, wherein the set of instructions, with the at least one processor, being configured to receive invoice data for the cashless transaction from an accounting data processing platform comprises:
causing the computer system to submit an API call to the accounting data processing data platform, the API call comprising a unique identifier comprising one or more of:
the user associated with the transaction;
a cashless payment identifier;
a cashless transaction identifier;
a purchaser identifier; or
an invoice identifier.

15. A computer program embodied on a non-transitory computer readable medium, the computer program when executed is configured to cause at least one processor to:
receive payment data for a cashless transaction from a payment processing data platform;
receive invoice data for the cashless transaction from an accounting data processing platform;
reconcile the payment data for the cashless transaction with the invoice data for the cashless transaction; and
render a display of the reconciled cashless transaction data to a user associated with the transaction.

16. The computer program product of claim 15, wherein the computer program product is further configured to cause at least one processor to:
transmit the reconciled cashless transaction data to the accounting data processing platform.

17. The computer program product of claim 16, wherein the computer program product is further configured to cause at least one processor to:
in response to a type of accounting data processing platform, map a set of data fields from the payment data into a set of data fields from the invoice data such that the reconciled cashless transaction data is readable by the accounting data processing platform;
receive, from the accounting data platform, an application programming interface (API) call requesting the reconciled cashless transaction data;
authenticate the accounting data platform with the user associated with the cashless transaction; and
in response to an authenticated API call, transmit the reconciled cashless transaction data to the accounting data platform.

18. The computer program product of claim 15, wherein the computer program product is further configured to cause at least one processor to:
prior to rendering the display of the reconciled cashless transaction data to a user associated with the cashless transaction:
map a set of data fields from the payment data into a set of data fields from the invoice data;
host a database accessible by the user associated with the cashless transaction;
store the reconciled transaction data in a database accessible by the user associated with the cashless transaction; and
permit remote access to the reconciled cashless transaction data in the database in response to authentication of a device associated with the user associated with the cashless transaction.

19. The computer program product of claim 15, wherein the computer program product being configured to cause at least one processor to receive payment data for the cashless transaction from a payment processing data platform comprises:
submit an API call to the payment processing data platform, the API call comprising a unique identifier comprising one or more of:
the user associated with the cashless transaction;
a cashless payment identifier;
a cashless transaction identifier;
a purchaser identifier; or
a vendor identifier.

20. The computer program product of claim 15, wherein the computer program product being configured to cause at least one processor to receive payment data for the cashless transaction from an accounting data processing platform comprises:
submit an API call to the accounting data processing data platform, the API call comprising a unique identifier comprising one or more of:
the user associated with the transaction;
a cashless payment identifier;
a cashless transaction identifier;
a purchaser identifier; or
an invoice identifier.
